(19) United States
(12) Patent Application Publication
(10) Pub. No.: US 2011/0300063 A1
(43) Pub. Date: Dec. 8, 2011

(54) FULLERENE BASED HYDROGEN STORAGE SYSTEM

(75) Inventors: Charles Washington Phillips, III, Bainbridge Island, WA (US); Clyde L. Scandrett, Spreckels, CA (US); John R. Lloyd, East Lansing, MI (US); Tengfei Luo, Somerville, MA (US)

(73) Assignee: The Government of the United States of America, as represented by the Secretary of the Navy, Arlington, VA (US)

(21) Appl. No.: 12/708,808

(22) Filed: Feb. 19, 2010

Related U.S. Application Data
(60) Provisional application No. 61/153,922, filed on Feb. 19, 2009.

(51) Int. Cl. C01B 3/02; B32B 5/00; B32B 5/16; B32B 9/04

(52) U.S. Cl. 423/648.1; 428/408; 428/332; 428/323; 977/750; 977/734

(57) ABSTRACT

A hydrogen storage structure includes a plurality of graphene sheets arranged to form a stack with a plurality of spacers between adjacent graphene sheets in the stack. In one embodiment, the spacers are arranged to provide a distance ranging between 5 Å and 20 Å between adjacent graphene sheets. In one embodiment, the spacers are formed as graphene spheres having a diameter that ranges from 5 Å to 15 Å. In another embodiment, the spacers are formed as graphene single-walled nanontubes having a length that ranges from 5 Å to 20 Å. In a further embodiment, the spacers are formed as graphene sheets having a thickness that ranges from 5 Å to 20 Å. In one embodiment, the plurality of graphene sheets is doped with lithium. In one embodiment, the lithium doping concentration is a ratio of one lithium atom per three carbon atoms.

### CROSS-REFERENCE TO RELATED APPLICATIONS

This application claims the benefit of U.S. Provisional Application No. 61/153,922, filed Feb. 19, 2009, which is hereby incorporated in its entirety by reference.

### BACKGROUND OF THE INVENTION

1. Field of the Invention

The present invention relates generally to apparatus and methods for storing hydrogen for use as a fuel. In particular, this invention relates to storing hydrogen in carbon-based media, such as for use in alternative fuel vehicles.

2. Description of the Related Art

As the 21st century progresses the need for alternative forms of energy continues to rise. In the wake of ever-rising oil prices suitable alternative energy sources are necessary. One of the most attractive alternatives is hydrogen. Hydrogen has such an appeal because it can be easily created via electrolysis of water, a resource that is much more abundant than foreign oil. The successful use of hydrogen could allow the United States to reduce its dependence on oil rich nations and curb global effects due to fuel based emissions, enabling it to turn its attention on other pressing domestic problems. Hydrogen has the potential to ameliorate the world's energy problems, but at the present time current technology cannot store hydrogen at a sufficient weight percentage.

The automobile industry has become the forefront in the search for alternative fuels. Many companies, including BMW, Honda, Toyota, and Ford have created hydrogen-fueled vehicles. These vehicles provide a dual gas and hydrogen fuel system that allows the vehicles to travel on average 300 miles on gas and 150 miles on hydrogen. Although this is a start, there is still a large dependence on gasoline in these vehicles. The main problem is that modern technology cannot enable the auto manufacturers to design a car solely powered by hydrogen while maintaining the goal of 300 miles per tank. This problem lies in the onboard storage capacity for hydrogen.

Current technology has hydrogen stored in liquid form at −418° F. in a 17.5 lb tank. The tank is vacuum insulated and is effective at maintaining hydrogen in its liquid state. However, in this form of hydrogen storage, advances in storage capacity are based on advances in insulation technology and not on hydrogen itself. Benchmarks for hydrogen storage are based upon the U.S. DOE targets for on-board systems. Between 5 and 13 kilograms of hydrogen are required to provide fuel for a car to travel 300 miles.

### SUMMARY OF THE INVENTION

The present invention is directed to an apparatus and method for storing hydrogen using fullerenes between graphene sheets as the storage medium. A fullerene is any molecule composed entirely of carbon, in the form of a hollow sphere, ellipsoid or tube. Spherical fullerenes are also called buckyballs, and cylindrical fullerenes are called carbon nanotubes or buckytubes. Fullerenes are similar in structure to graphite, which is composed of stacked graphene sheets of linked hexagonal rings; but they may also contain pentagonal (or sometimes heptagonal) rings. This invention is directed to a pillared geometry of single-walled fullerenes separating parallel graphene sheets. The physical system may be comprised of stacked layers of graphene either supported, or unsupported, by various sized single-walled carbon nanotubes (SWNTs). The present invention includes the use of graphene sheets with single-walled carbon nanotubes, buckyballs, or small graphene sheets (also referred to herein as small graphene layers) as pillars to store hydrogen as an alternative to the current technology of compressed liquid hydrogen in a cylinder. This particular system has shown promise to meet and possibly exceed the USDOE goal for of 6.5 wt % hydrogen. The major result achieved by the invention is confirmation that 7.7 wt % hydrogen can be stored using graphene sheets.

A hydrogen storage structure according to the present invention includes a plurality of graphene sheets, also referred to as graphene sheets, arranged to form a stack, and a plurality of spacers arranged between adjacent graphene sheets in the stack. The spacers preferably are arranged to provide a distance between adjacent graphene sheets ranging between 5 Å (angstroms) and 20 Å. In one embodiment, the spacers are formed as graphene spheres having a diameter that ranges from 5 Å to 15 Å. In another embodiment, the spacers are formed as graphene single-walled nanontubes having a length that ranges from 5 Å to 20 Å. In a further embodiment, the spacers are formed as small, pillared graphene layers having a thickness that ranges from 5 Å to 20 Å.

In the hydrogen storage structure according to the present invention the plurality of graphene sheets may be doped with lithium. In one embodiment, the lithium doping is a lithium doping concentration ratio of one lithium atom per three carbon atoms.

Embodiments in accordance with the invention are best understood by reference to the following detailed description when read in conjunction with the accompanying drawings, which are not drawn to any scale.

### BRIEF DESCRIPTION OF THE DRAWINGS

FIG. 1A is an elevation view showing a first embodiment of the invention having graphene spheres positioned between graphene sheets.

FIG. 1B is an elevation view showing a second embodiment of the invention having graphene nanotubes positioned between graphene sheets.

FIG. 1C is an elevation view showing a third embodiment of the invention having small, pillared graphene layers arranged to function as spacers between larger graphene sheets.

FIG. 2 illustrates a graphene sheet.

FIG. 3 illustrates a carbon nanotube.

FIG. 4 illustrates a nanotube wrap angle.

FIG. 5 illustrates hydrogen atoms fixed above a carbon atom.

### DETAILED DESCRIPTION OF THE INVENTION

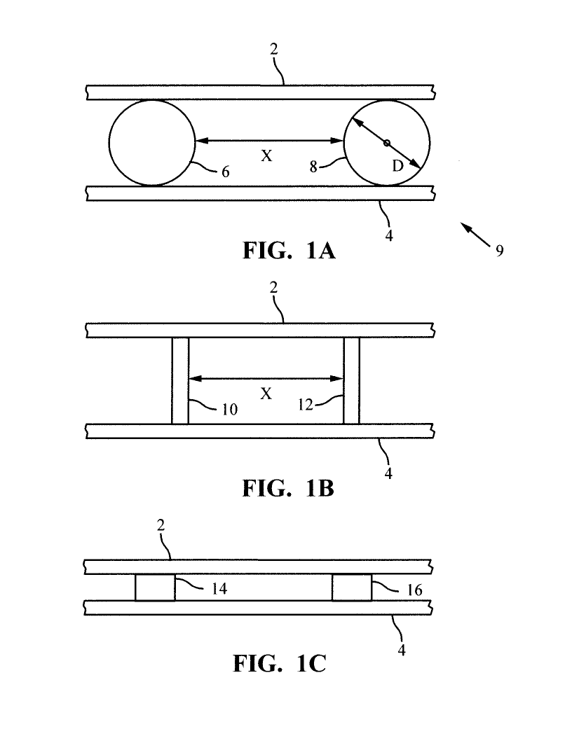

FIG. 1A represents a pair of graphene sheets 2 (a first graphene sheet) and 4 (a second graphene sheet) spaced apart by a pair of graphene spheres 6 and 8, which are commonly called “buckyballs.” It is to be understood that the arrangement of spheres 6 and 8 of FIG. 1 repeats periodically between the two graphene sheets 2 and 4. The spheres 6 and 8 preferably form a rectangular array and preferably have diameters D in the range of 5 Å (angstroms) to 15 Å and are spaced apart by a distance X that, in one embodiment, is in the range of 10 Å to 500 Å. In one embodiment, graphene sheets 2 and 4 are rectangular in shape with sides of up to 1 m in length and, in one embodiment, are spaced apart by 5 Å to 20 Å. There may be additional graphene sheets (not shown) and spheres (not shown) arranged to form a stack 9 of graphene sheets with an array of spheres between facing adjacent graphene sheets.

FIG. 1B shows a structure similar to that of FIG. 1A with the difference being that graphene spheres 6 and 8 are replaced by small graphene cylinders 10 and 12, respectively. The cylinders are commonly called single-walled carbon nanotubes or SWNTs.

FIG. 10 shows another embodiment of the invention where support layers 14 and 16 are placed between the graphene sheets 2 and 4. In one embodiment support layers 14 and 16 are formed of graphene. In one embodiment, support layers 14 and 16 are formed as small, pillared graphene layers.

As explained in detail subsequently, hydrogen will adsorb in the stack 9 between layers 2 and 4.

Graphene is a one-atom-thick planar sheet of sp² bonded carbon atoms that are densely packed in a honeycomb crystal lattice. It can be visualized as an atomic-scale chicken wire made of carbon atoms and their bonds. Graphene is the basic structural element of some carbon allotropes including graphite, carbon nanotubes and fullerenes.

A process for making graphene sheets is described by Prachi Patel in an article entitled “How to Make Graphene” published in MIT publication, Technology Review, Monday Apr. 14, 2008. The process begins by making a suspension of graphene oxide flakes. The graphite flakes are oxidized with sulphuric or nitric acid. This inserts oxygen atoms between individual graphene sheets and forces them apart, resulting in graphene oxide sheets, which are suspended in water. The suspension is filtered through a membrane that has 25-nanometer-wide pores. Water passes through the pores, but the graphene oxide flakes, each of which is a few micrometers wide and about one nanometer thick, cover the pores. When a flake covers a pore, water is directed to its uncovered neighbors, which in turn get covered, until flakes are distributed across the entire surface. The method allows deposition of single layers of graphene and results in a nearly uniform film deposited on the membrane. The film-coated side of the membrane is placed on a substrate, such as glass or plastic, and the membrane is washed away with acetone. Finally, the film is exposed to hydrazine, which converts the graphene oxide into graphene.

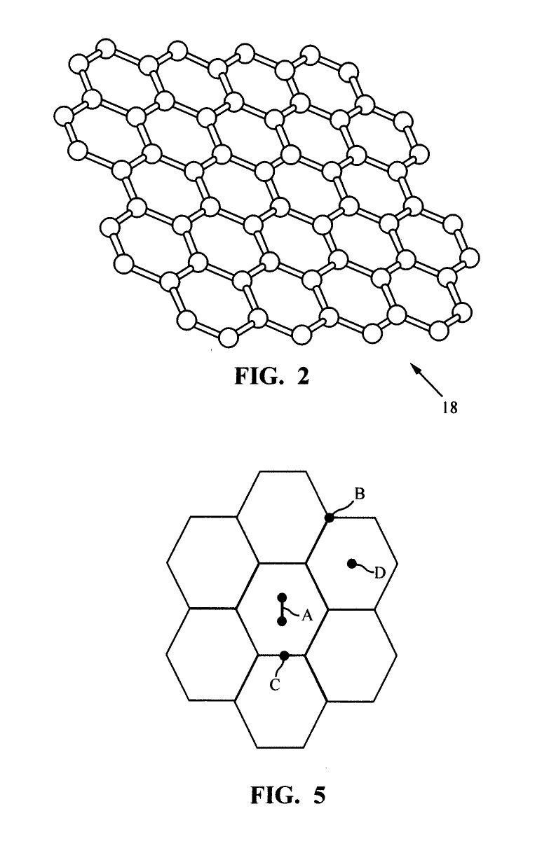

Graphene can be thought of as carbon in two dimensions. It is a hexagonal lattice of coplanar carbon atoms. A graphic example of a graphene sheet 18 can be seen in FIG. 2. Graphene is the basic building block for carbon nanotubes. Graphene is thermodynamically stable, and it has a high crystal quality and macroscopic continuity that remains monocrystalline without degradation when separated from its parent graphite crystal. Furthermore, graphene has a pronounced electric field effect and is considered to be either a shallow-gap semiconductor or a small-overlap semi-metal. All these properties help make graphene a suitable candidate for hydrogen storage. Graphite consists of many layered sheets of graphene with strong in-plane bonds and weak van der Waals forces between layers. The van der Waals forces between a layer and its parent crystal can be broken, resulting in a “peeled” two-dimensional graphene sheet. Mechanical cleavage is used to produce graphene sheets. Mechanical cleavage involves rubbing two fresh surfaces of graphite together, creating shavings similar to chalk on a chalkboard. Shavings fall onto an oxidized silicon wafer where monolayers can be isolated using an optical microscope. Once identified, their presence is confirmed using atomic force microscopy.

Graphene has the ability to absorb/adsorb gas molecules from the environment. Absorption typically results in the doping of a graphene sheet with either electrons or holes. When placed in hydrogen-rich environment, graphene and other graphene based carbon structures are able to adsorb hydrogen.

Single-walled carbon nanotubes are created from graphene sheets that have been rolled up into tubes with diameters as small as one nanometer and lengths up to 2 millimeters. The extremely small diameter and relatively larger length give nanotubes a one-dimensional characteristic. Nanotubes have high tensile strengths and elastic moduli similar to materials like steel.

SWNTs are classified by their chirality; the way the graphene sheet is wrapped to form the tube. A SWNT is obtained by curling a graphene sheet such that a hexagon in the edge of the graphite surface meets another hexagon. Assuming that the center of one hexagon is the origin, the position of the center of another hexagon in the original flat sheet relative to the origin is expressed by a chiral vector (n, m) where n and m are integers in the equation R=na₁+ma₂, i.e. the number of unit vectors along two dimensions in the honeycomb crystal lattice of graphene. Any vector with m=0 characterizes a zigzag nanotube. A chiral vector with m=n represents an armchair nanotube, and any other chiral vector classifies other possible nanotube types. These vectors also define a wrapping angle for the graphene sheet measured from the armchair line (i.e. the armchair nanotube has a wrap angle equal to 0 as the chiral vector lies along the armchair line). The zigzag nanotube has a wrap angle equal to 30 degrees as measured from the armchair line. Lastly, chiral nanotubes have wrap angles with any other value: 0<x<30 and 30<x≦90. An example of an SWNT is shown in FIG. 3 as SWNT 20, while the vectors and wrap angles are shown in FIG. 4.

The chirality of the SWNT determines many of its characteristics; such as conductance, density, lattice structure, and other properties like the ability to store hydrogen. For instance, an SWNT is considered metallic if n−m is divisible by three, and is otherwise considered semi-conducting. Additionally, the diameter of a nanotube with chiral vector (n, m) can be determined from the following equation:

$$d = \frac{a \sqrt{3}}{π} \sqrt{{n}^{2} + {m}^{2} + mn} \qquad ( 1 )$$

Here, the value of a dictates the c-c bond length, typically found to be about 1.42 Å, and the resultant diameter is given in angstroms as well.

SWNTs often have end-caps. Although there is a large open space in the interior, usually both ends are capped with semi-fullerene structures. The end caps must be removed in order to maximize the potential for hydrogen storage. Typically either oxidization or chemical treatment is used.

A buckyball (buckminsterfullerene), often referred to as a C₆₀ molecule, is a spherical carbon structure with sixty carbon atoms. The ball consists of twenty hexagons and twelve pentagons arranged like a soccer ball in which no two pentagons have a common edge. It is the most naturally occurring fullerene and can be found in soot. The C₆₀ molecule has a diameter of about seven angstroms. In one embodiment, buckyballs are used as pillars in lieu of nanotubes and small graphene layers.

Hydrogen can interact with nanotubes and graphene sheets either by physisorption or chemisorption. In physisorption (also adsorption), intact hydrogen molecules are weakly attracted to the nanotubes or graphene sheets while in chemisorption, covalent carbon-hydrogen bonds are formed. It is hypothesized that the mechanism for chemisorption is a fractional electronic charge transfer between the hydrogen molecule and carbon with the hydrogen molecule remaining intact.

Due to the fact that hydrogen molecules are non-spherical, different molecule orientations for physisorption to a graphene sheet are possible. Orientations are also relevant to SWNTs as they differ from graphene only in the curvature of the carbon layer. The most stable configuration of physisorbed hydrogen is above the center of a carbon hexagon and parallel to the hexagon's plane. In the parallel configuration, the molecular axis of the hydrogen molecule is perpendicular to two parallel sides of the carbon hexagon.

Density Functional Theory (DFT) was used to compute the electronic density and total energy of the molecular system with Local Density Approximation (LDA) used for exchange and correlation. Density Functional Theory is based upon the idea that an interacting system of fermions can be described by their density rather than by their many-body quantum mechanical wave functions. This means that for N electrons in a solid that obey the Pauli uncertainty principle and repulse each other via the Coulomb potential, the basic variable of the system depends only on the three spatial coordinates x, y, and z rather than 3N degrees of freedom representing each electron's position. The local density approximation computes the exchange-correlation functional in DFT by taking the exchange-correlation energy of an electron in a homogeneous electron gas of a density equal to the averaged density at the position of the electron in the system being calculated. It is the simplest approximation as the electron exchange and correlation energy at any point in space is only a function of the electron density at that point.

The background electron density is lower in the hollow sites above the centers of carbon hexagons versus the channels on top of the skeleton of carbon-carbon bonds. The attraction forces for hydrogen physisorption are due to the exchange-correlation contribution while the repulsion forces are due to the close-shell electronic structure of the hydrogen molecule.

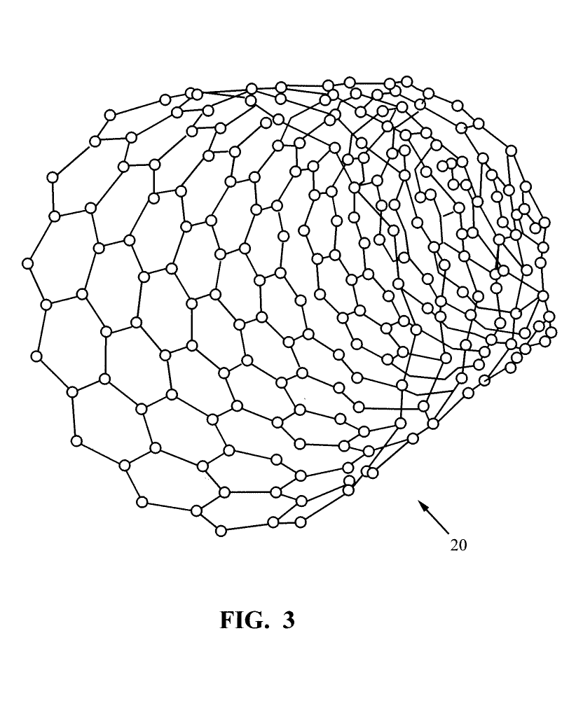

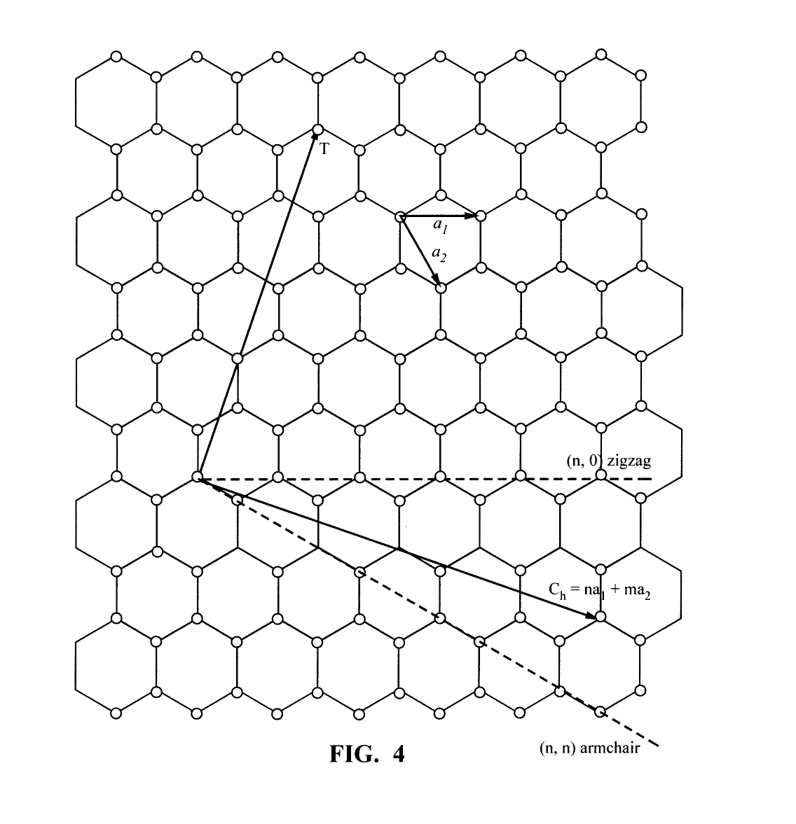

Referring to FIG. 5, although the position A above the center of the carbon hexagon is the more optimal position for hydrogen physisorption, there are alternate binding sites. Other positions include: position B above one carbon atom, position C above the center of a carbon-carbon bond, and, like the parallel case, position D above the center of a hexagon of carbon atoms but perpendicular to their plane of orientation. Binding energy and equilibrium distances are not largely affected by these differences. The highest binding energy obtains in the A orientation and the smallest binding energy occurs when the hydrogen molecule is in the B position. These four arrangements are shown in FIG. 5.

Since the basic carbon structure of SWNTs is almost identical to a graphene sheet, hydrogen interactions are similar. Major differences are that SWNTs have outer walls, inner walls, and interstitial channels (the area in between the outer walls of adjacent nanotubes) to which hydrogen molecules can adsorb. In the case of adsorption with the outer wall of a single nanotube, hydrogen has a similar interaction with minor variations due to the curvature of the nanotube. The effects of curvature on adsorption to inner walls of nanotubes may have a more pronounced effect due to added repulsion of hydrogen molecules competing for preferred binding sites.

The roles of the longitudinal and lateral diffusion coefficients for hydrogen in SWNTs are dominant processes in filling and voiding potential binding sites. Large diffusion coefficients are advantageous in this regard. Diffusion also plays a key role in the movement of hydrogen molecules that are not statically bound to carbon structures. Hydrogen molecules are constantly exchanging adsorption sites and diffusing. Diffusion coefficients are relatively independent of nanotube diameter, hydrogen density, or nanotube chirality.

Hydrogen adsorption is largely dependent upon loading. Higher or lower concentrations of hydrogen surrounding the carbon structure dictate where hydrogen molecules distribute themselves on the carbon lattice. Specifically, SWNTs have two distinct adsorption sites: exohedral and endohedral. Endohedral sites are located internal to the SWNT while exohedral sites are located exterior to or in interstitial pores between nanotubes. Distribution of hydrogen between the exohedral and endohedral sites is determined by adsorption thermodynamics and that entropic effects arising from differences in pore geometry and free pore volume are negligible.

The exohedral sites are filled first upon hydrogen uptake. This initial preference is due to the fact that there are stronger interactions on the exterior of the curved carbon surface. As the hydrogen loading continues to increase the endohedral sites in nanotubes with large diameters become populated. The change in distribution is due to competition between the more energetically favorable adsorption at the exohedral position, and the repulsive interactions when the density of hydrogen gets too high in interstitial sites. Chirality is the characteristic that has the least effect on hydrogen adsorption. Although changes in chirality can indirectly change the diameter and thus have an effect on adsorption, changes in chirality with tubes of similar diameter had no noticeable effects on adsorption energy.

Doping is the process of adding electrons to carbon structures using dopants like Lithium or Potassium. Injections of “free” electrons to the carbon structure result in additional sites for hydrogen adsorption and thereby increase storage capacity.

Lithium doping of the carbon structure generates two new adsorption sites in addition to the endohedral, exohedral, and interstitial sites. The first site is on the nanotube sidewall, where electronic distribution is deformed by the lithium (Li) atoms. The second site is on the positively charged Li atom itself.

The doping concentration ratio (ratio of Li:C atoms) linearly affects storage capacity. The chemical basis for this conclusion is that the high electron affinity of the sp² carbon framework, found in graphene sheets and SWNTs with larger diameters, can separate charge from lithium atoms that in turn help stabilize hydrogen molecules. In one embodiment, a lithium doping concentration ratio of 1:3 (Li:C) provides an optimal hydrogen storage capacity.

The various effects of adsorption help in determining an optimum model for simulating hydrogen storage in carbon structures. A system of aligned nanotubes sandwiched between two graphene sheets may also be used to store hydrogen.

Chemisorption is the process whereby a molecule adheres to a surface via the formation of a chemical bond. Although it can be similar to physisorption, the major distinction is that chemisorption is due to stronger chemical bonds while physisorption is due to the weaker attractive van der Waals forces. The process of chemisorption also involves higher temperatures, enthalpy, and activation energy than the process of physisorption. The chemisorption process for hydrogen in carbon structures is referred to as hydrogenation.

The basic process for hydrogenation is that H atoms saturate the carbon-carbon n bonds and cause them to break, allowing carbon-hydrogen covalent bonds to form. This process is reversible, as it has been shown that the carbon-hydrogen bonds break at temperatures above 600 degrees Celsius.

The hydrogenation process occurs naturally in a carbon-hydrogen environment. However, it does not occur frequently enough for hydrogen storage above USDOE 2010 levels. It is thought that at ambient temperature a combination of physisorption and chemisorption processes are acting.

Research has shown that a forced hydrogenation environment could result in 7.5 wt % hydrogen storage. Atomic hydrogen beam treatment may be used to increase hydrogenation and subsequent storage in carbon nanotubes. Beam treatment caused a re-hybridization of carbon atoms from sp² to sp³ configurations, enhancing the likelihood of carbon-hydrogen bonds.

The geometrical configuration includes two single-walled carbon nanotubes sandwiched between two graphene sheets. Hydrogen molecules in the system are free to move and interact with carbon atoms in both chemisorption and physisorption processes described earlier. The carbon atoms of the system, however, are fixed based on the structure of the SWNTs and graphene sheets. These fixed positions generally prevent carbon atoms from covalent bonding with each other. Although there are some instances in which carbon atoms in the SWNT bond with the graphene layer, the carbon-carbon atomic interactions are primarily those due to potential energy considerations and van der Waals forces. A large majority of hydrogen molecules reached their equilibrium positions after 5 ps.

Large SWNT diameters and surface areas prohibit many hydrogen molecules from achieving equilibrium positions resulting in a lowering of the overall wt % H₂. SWNTs can be constructed with varying diameters that may be important in the construction of optimally stacked graphene sheets. Another possible advantage to the use of SWNTs would be if channeling hydrogen flow became an important issue.

Other fullerenes, such as buckyballs or smaller graphene layers, may be used as pillars. In one embodiment, the equilibrium spacing between the center of a buckyball and a graphene sheet of 6.508 Å combined with the significantly smaller surface area of a buckyball suggest an optimized pillared geometry of 13.016 Å.

Accordingly, it can be understood by those of skill in the art, the above described embodiments of fullerene based hydrogen storage structures described herein and the methods for forming the structures are adaptable for use in fabrication of hydrogen fuel storage containers. As an example, a hydrogen fuel storage container could be formed with an approximate volume of 0.125 m³. The hydrogen fuel storage container would include a fullerene layered structure as earlier described herein, such as with reference to FIGS. 1, 2, and 3. Hydrogen fuel would be loaded into the hydrogen fuel storage container and would physisorb to the graphene sheets, for example with an approximate weight percent of 15.4%. When the hydrogen fuel is required for use, the hydrogen would desorb from the graphene sheets and exit for combustion use.

This disclosure provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

What is claimed is:

1. A hydrogen storage structure, comprising:
a plurality of graphene sheets arranged to form a stack; and
a plurality of spacers arranged between adjacent graphene sheets in said stack.

2. The hydrogen storage structure of claim 1 wherein said plurality of spacers are arranged to provide a distance ranging between 5 Å and 20 Å between adjacent graphene sheets.

3. The hydrogen storage structure of claim 1 wherein said plurality of spacers are graphene spheres having a diameter ranging from 5 Å to 15 Å.

4. The hydrogen storage structure of claim 1 wherein said plurality of spacers are graphene single-walled nanotubes having a length ranging from 5 Å to 20 Å.

5. The hydrogen storage structure of claim 1 wherein said plurality of spacers are small, pillared graphene layers having a thickness ranging from 5 Å to 20 Å.

6. The hydrogen storage structure of claim 1 wherein said plurality of graphene sheets are doped with lithium.

7. The hydrogen storage structure of claim 6 wherein said plurality of graphene sheets are doped with lithium at a doping concentration ratio of one lithium atom per three carbon atoms.

8. A hydrogen storage structure, comprising:
a first graphene sheet;
a second graphene sheet, said second graphene sheet adjacent said first graphene sheet and arranged to form a stack; and
a plurality of spacers arranged between said first graphene sheet and said second graphene sheet in said stack.

9. The hydrogen storage structure of claim 8 wherein said plurality of spacers are arranged to provide a distance ranging between 5 Å and 20 Å between said first graphene sheet and said second graphene sheet.

10. The hydrogen storage structure of claim 8 wherein said plurality of spacers are graphene spheres having a diameter ranging from 5 Å to 15 Å.

11. The hydrogen storage structure of claim 8 wherein said plurality of spacers are graphene single-walled nanotubes having a length ranging from 5 Å to 20 Å.

12. The hydrogen storage structure of claim 8 wherein said plurality of spacers are small, pillared graphene layers having a thickness ranging from 5 Å to 20 Å.

13. A method for storing hydrogen comprising:
arranging a plurality of graphene sheets to form a stack; and
spacing adjacent graphene sheets in said stack apart with a plurality of spacers, said plurality of spacers arranged between said adjacent graphene sheets.

14. The method of claim 13 further comprising:
arranging said plurality of spacers to provide a distance between adjacent graphene sheets ranging between 5 Å and 20 Å.

15. The method of claim 13 further comprising:
forming said plurality of spacers as graphene spheres having a diameter ranging from 5 Å to 15 Å.

16. The method of claim 13 further comprising:
forming said plurality of spacers as graphene single-walled nanontubes having a length ranging from 5 Å to 20 Å.

17. The method of claim 13 further comprising:
forming said plurality of spacers as small, pillared graphene layers having a thickness that ranges from 5 Å to 20 Å.

18. The method of claim 13 further comprising:
doping said plurality of graphene sheets with lithium.

19. The method of claim 18 wherein said plurality of graphene sheets are doped with lithium at a lithium doping concentration ratio of one lithium atom per three carbon atoms.

20. The method of claim 13 further comprising:
introducing hydrogen fuel into said plurality of graphene sheets wherein said hydrogen fuel is stored within said plurality of graphene sheets.
